(19) United States
(12) Patent Application Publication
(10) Pub. No.: US 2012/0150809 A1
(43) Pub. Date: Jun. 14, 2012

(54) DISASTER RECOVERY SERVICES

(75) Inventors: Prashant Parikh, Holtsville, NY (US); Donald Kleinschnitz, Sandy, UT (US)

(73) Assignee: COMPUTER ASSOCIATES THINK, INC., Islandia, NY (US)

(21) Appl. No.: 12/963,202

(22) Filed: Dec. 8, 2010

(51) Int. Cl. G06F 17/00

(52) U.S. Cl. 707/653; 707/E17.007

(57) ABSTRACT

A system and method for server recovery and migration is presented. The method comprises backing up data and device drivers on a server to a central location, logging-in to the central location, obtaining the backed up data and device drivers from the central location, copying the obtained data to a computer medium and booting the server using the computer medium. In one aspect, the method can further comprise determining whether recovery is needed and performing logging-in, obtaining, copying, and booting when the recovery is needed. In one aspect, the method can further comprise determining whether the server has new device drivers and backing up the device drivers when the server has new device drivers. In one aspect, the backing up is performed periodically. In one aspect, the computer medium is a CD. In one aspect, the obtained backed up data is an ISO file.

### FIELD

The present disclosure relates generally to computer systems, migration, backup and recovery systems, and more particularly to disaster recovery and bare metal restore.

### BACKGROUND

Minimizing data loss and providing continuous data protection in a centralized, unified and automated management solution keeps an organization operating interruption free. Organizations use disaster recovery (DR) to recover access to their software, data, and/or hardware that are needed to resume the performance of normal, critical business functions after the event of either a natural disaster or a disaster caused by humans. Part of DR often includes preparation for a bare metal restore or recovery (BMR), which is the process of reformatting a computer from scratch after a catastrophic failure. Typically the BMR process involves reinstalling the operating system and software applications and then, if possible, restoring data and settings.

During the DR process, the end user will need all the drivers from the failed system to access the mass storage device (disk) to record the data and network drivers to make sure that the data on the network disk is accessible during BMR process. Unfortunately, at this time, the user might not have all the drivers needed for all the different servers in his environment. Thus the user will have to put forth significant efforts to find the drivers and to enable a successful BMR. Accordingly, there is a need for a system and method able to store drivers as well as data in an easily accessible location to facilitate DR.

### BRIEF SUMMARY

A method and system for disaster recovery and bare metal restore is presented. The novel approach centralizes the backups and metadata on a DR server environment and when any user's server crashes, the user can create a boot disk or a boot environment from information stored on a DR server in the DR server environment, and the user can re-boot the failed server or boot up a new server using the boot disk. The rebooted or booted-up server is recovered without the user needing to add any new drivers at recovery time. The user can also add custom drivers to the DR server environment which can be used at the time of recovery.

The method for server recovery and migration comprises backing up data and device drivers on a server to a central location, logging-in to the central location, obtaining the backed up data and device drivers from the central location, copying the obtained data to a computer medium and booting the server using the computer medium. In one aspect, the method can further comprise determining whether recovery is needed and performing logging-in, obtaining, copying, and booting when the recovery is needed. In one aspect, the method can further comprise determining whether the server has new device drivers and backing up the device drivers when the server has new device drivers. In one aspect, the backing up is performed periodically. In one aspect, the computer medium is a CD. In one aspect, the obtained backed up data is an ISO file.

The system for server recovery and migration comprises a processor, a managing platform, one or more servers and a module operable to back up data and device drivers on the one or more servers to the managing platform, to log-in to the managing platform, obtaining the backed up data and device drivers from the managing platform for one of the one or more servers, copying the obtained data to a computer medium, and booting the one server using the computer medium. In one aspect, the module is also operable to determine whether recovery is needed and perform logging-in, obtaining, copying, and booting when the recovery is needed. In one aspect, the module is also operable to determine whether the one server has new device drivers, and back up the device drivers when the one server has new device drivers. In one aspect, the backing up is performed periodically. In one aspect, the computer medium is a CD. In one aspect, the obtained backed up data is an ISO file.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a block diagram of a computer network infrastructure in one embodiment of the present invention.

FIG. 2 is a flow diagram of the inventive system.

### DETAILED DESCRIPTION

To fully protect an organization's data, it can be migrated offsite and be quickly recoverable when needed. There is software, such as CA ARCserve Replication software, from CA Technologies, that eases migration between servers and locations, delivers continuous data protection to complement existing backups, and helps ensure that the organization's data is always available. Such software can include support for both data and metadata replication allowing, for example, for granular protection of individual web sites, corporate servers, application servers, etc.

An inventive system and method for disaster recovery and bare metal restoration is presented. In this novel technique, when a server is backed up, all the drivers (network and mass storage) and all relevant information is extracted. All of this information is stored on the managing platform or server environment in a specific user account. When a user gets new servers, the new server information can be collected, extracted and stored in the user's account. In one embodiment, the information is transmitted over the internet to the managing platform.

At the time of the BMR, the user can connect or log-in to his account and the inventive technology can provide him with an ISO image, such as a CD image with files. This ISO will contain all the necessary files to boot a server of the CD, e.g., a WinPE Image, and all the drivers associated with this user's server. The user can burn this ISO on to a CD and use the CD to boot the crashed or failed server and continue the BMR process.

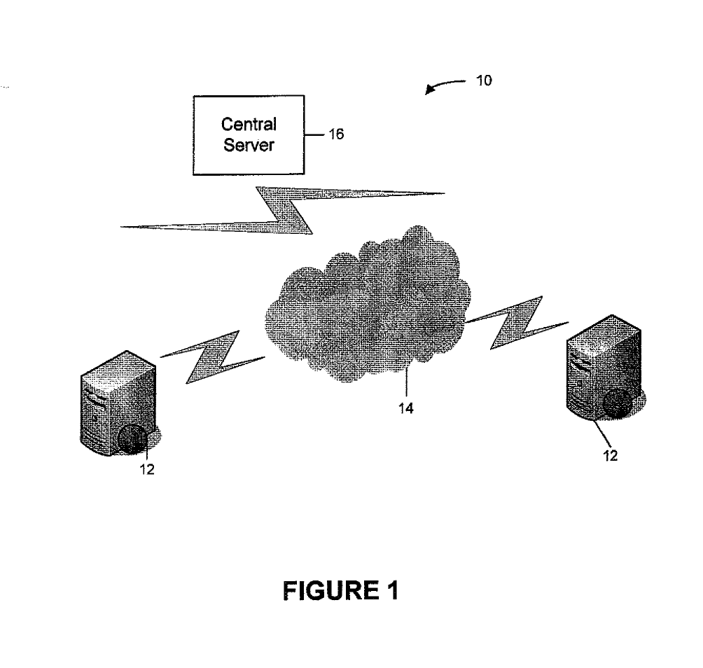

FIG. 1 is a block diagram of a computer network infrastructure 10 suitable for use with the present invention. As shown in FIG. 1, a variety of computing environments or servers 12 are interconnected by a network 14 or a series of networks. A DR server environment which may include a central server, such as a DR server, or a managing platform 16 stores the data and the device drivers that are back-up copies of each user server 12. In one embodiment, the central server 16 can reside in the cloud.

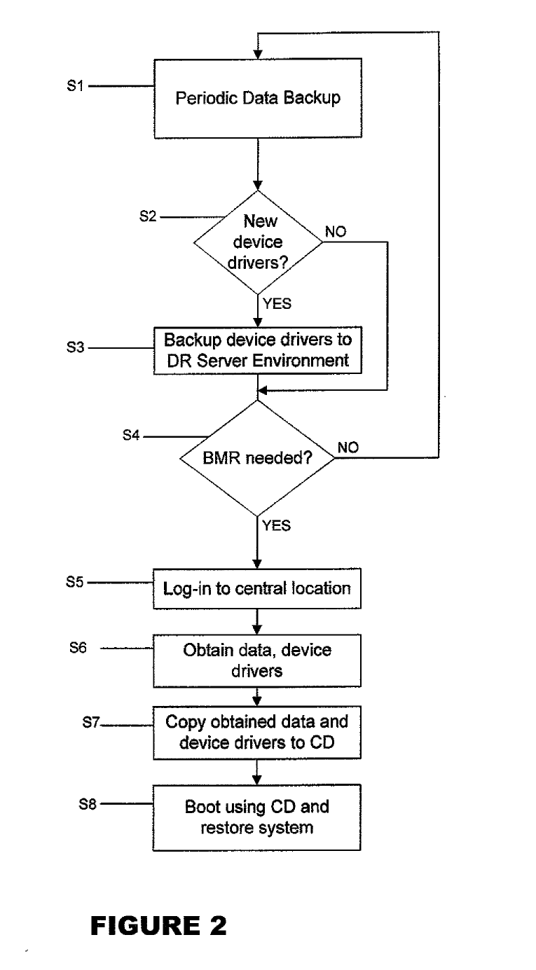

FIG. 2 is a flow diagram of the inventive method. In step S1, data is backed up from a user's server 12 to a central location 16. This backup includes data, metadata and all drivers, such as device drivers, necessary for the user's server to operate. This backup typically occurs periodically, such as on a daily, weekly or monthly basis.

If, after a periodic backup is performed, new device drivers have been implemented on the user's server 12 (S2=YES), then these device drivers are backed up to the DR server environment in step S3. Otherwise (S2=NO), no device driver backup is performed.

Generally, recovery is needed when a user's server fails or crashes. If recovery is needed (S4=YES), the inventive BMR process continues. In step S5, the user with the failed server log-ins to his account and, in step S6, obtains an ISO image, including the data and device drivers retrieved from the central location 16. This ISO contains all the necessary files to re-boot the failed server or boot a copy of it. The ISO is copied to a CD or other medium in step S7. In step S8, the CD is used to re-boot the failed server or to boot a new server as a copy of the failed server. In one embodiment, the server does not fail but is selected by the user for other reasons. In this embodiment, the user can create a copy or perform migration of this selected server.

If recovery is not needed (S4=NO), then processing returns to step S1 and data backup is performed at the appropriate time.

At backup time, the backup process collects all the information which is necessary for BMR. This includes at least disk information, partition information, volume information, and drivers (mass storage). The collected information is stored as objects or files with the backups.

At restore time, e.g., DR, the information collected in the backup process is read and the necessary drivers are loaded. Then the layout of the disk is performed including partitions in accordance with the backed up information, and then the data is restored.

The inventive system and method advantageously allows a user to perform DR and BMR without having the required server drivers available on a USB or other external device at the time of the restore or recovery. This enables worry free recovery procedure.

In addition, the novel process supports easy migration from one server to a different make and/or model server. Beneficially, a user can recover servers without separate media; all of the required data resides in the central location. Thus, no advanced preparation for recovery or migration is required.

Various aspects of the present disclosure may be embodied as a program, software, or computer instructions embodied or stored in a computer or machine usable or readable medium, which causes the computer or machine to perform the steps of the method when executed on the computer, processor, and/or machine. A program storage device readable by a machine, e.g., a computer readable medium, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The computer readable medium could be a computer readable storage medium or a computer readable signal medium. Regarding a computer readable storage medium, it may be, for example, a magnetic, optical, electronic, electromagnetic, infrared, or semiconductor system, apparatus, or device, or any suitable combination of the foregoing; however, the computer readable storage medium is not limited to these examples. Additional particular examples of the computer readable storage medium can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an electrical connection having one or more wires, an optical fiber, an optical storage device, or any appropriate combination of the foregoing; however, the computer readable storage medium is also not limited to these examples. Any tangible medium that can contain, or store a program for use by or in connection with an instruction execution system, apparatus, or device could be a computer readable storage medium.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A method for server recovery and migration, comprising steps of:
backing up data and device drivers on a server to a central location;
logging-in to the central location;
obtaining the backed up data and device drivers from the central location;
copying the obtained data to a computer medium; and
booting the server using the computer medium.

2. The method according to claim 1, further comprising the steps of:
determining whether recovery is needed; and
performing the steps of logging-in, obtaining, copying, and booting when the recovery is needed.

3. The method according to claim 1, further comprising the steps of:
determining whether the server has new device drivers; and
backing up the device drivers when the server has new device drivers.

4. The method according to claim 1, wherein the backing up is performed periodically.

5. The method according to claim 1, wherein the computer medium is a CD.

6. The method according to claim 1, wherein the obtained backed up data is an ISO file.

7. A system for server recovery and migration, comprising:
a processor;
a managing platform;
one or more servers; and
a module operable to back up data and device drivers on the one or more servers to the managing platform, to log-in to the managing platform, obtaining the backed up data and device drivers from the managing platform for one of the one or more servers, copying the obtained data to a computer medium, and booting the one server using the computer medium.

8. The system according to claim 7, the module further operable to determine whether recovery is needed and perform logging-in, obtaining, copying, and booting when the recovery is needed.

9. The system according to claim 7, the module further operable to determine whether the one server has new device drivers, and back up the device drivers when the one server has new device drivers.

10. The system according to claim 7, wherein the backing up is performed periodically.

11. The system according to claim 7, wherein the computer medium is a CD.

12. The system according to claim 7, wherein the obtained backed up data is an ISO file.

13. A computer readable storage medium storing a program of instructions executable by a computer to perform a method for server recovery and migration, comprising:
backing up data and device drivers on a server to a central location;
logging-in to the central location;
obtaining the backed up data and device drivers from the central location;
copying the obtained data to a computer medium; and
booting the server using the computer medium.

14. The computer readable storage medium according to claim 13, further comprising:
determining whether recovery is needed; and
performing the logging-in, obtaining, copying, and booting when the recovery is needed.

15. The computer readable storage medium according to claim 13, further comprising:
determining whether the server has new device drivers; and
backing up the device drivers when the server has new device drivers.

16. The computer readable storage medium according to claim 13, wherein the hacking up is performed periodically.

17. The computer readable storage medium according to claim 13, wherein the computer medium is a CD.

18. The computer readable storage medium according to claim 13, wherein the obtained backed up data is an ISO file.
